(19) United States
(12) Patent Application Publication
(10) Pub. No.: US 2025/0036458 A1
(43) Pub. Date: Jan. 30, 2025

(54) SYSTEM AND METHOD FOR DETERMINING SYSTEM PERFORMANCE FOR APPLICATION MIGRATION

(71) Applicant: BANK OF AMERICA CORPORATION, Charlotte, NC (US)

(72) Inventor: Imad Maqbul Mulla, Mumbai (IN)

(73) Assignee: BANK OF AMERICA CORPORATION, Charlotte, NC (US)

(21) Appl. No.: 18/226,563

(22) Filed: Jul. 26, 2023

(51) Int. Cl. G06F 9/48; G06F 11/34

(52) U.S. Cl. CPC G06F 9/4856; G06F 11/3476

(57) ABSTRACT

Systems, computer program products, and methods for determining system performance for application migration are provided. The method includes receiving an application test request from an end-point device associated with an application. The application test request includes an existing technology indicator and a new technology indicator. The method also includes causing an execution of at least a portion of the application using the at least one of the new technology types via a cloud device. The method further includes comparing one or more metrics for the application performed between at least one of the new technology type(s) and at least one of the existing technology type(s). The method still further includes determining a new technology performance indicator for each of the new technology type(s). The method also includes causing a transmission of the new technology performance indicator(s) to the end-point device associated with the application.

### TECHNOLOGICAL FIELD

Example embodiments of the present disclosure relate generally to application migration and, more particularly, to determining system performance for application migration.

### BACKGROUND

Applications are constantly being retrofitted for different technologies. As such, each technology creates different issues relating to operability. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

In an example embodiment, a system for determining system performance for application migration is provided. The system includes at least one non-transitory storage device containing instructions and at least one processing device coupled to the at least one non-transitory storage device. The at least one processing device, upon execution of the instructions, is configured to receive an application test request from an end-point device associated with an application. The application test request includes an existing technology indicator and a new technology indicator. The existing technology indicator indicates one or more existing technology types in which an application operates, and the new technology indicator indicates one or more new technology types in which the application is to be tested. The at least one processing device, upon execution of the instructions, is also configured to cause an execution of at least a portion of the application using the at least one of the one or more new technology types via a cloud device. The at least one processing device, upon execution of the instructions, is further configured to compare one or more metrics for the application performed on the at least one of the one or more new technology types with one or more metrics for at least one of the one or more existing technology types. The at least one processing device, upon execution of the instructions, is still further configured to determine a new technology performance indicator for each of the at least one of the one or more new technology types based on the comparison of the one or more metrics for the application performed on the at least one of the one or more new technology types with one or more metrics for at least one of the one or more existing technology types. The at least one processing device, upon execution of the instructions, is also configured to cause a transmission of the new technology performance indicator for one or more of the new technology types to the end-point device associated with the application.

In various embodiments, the at least one processing device, upon execution of the instructions, is configured to cause an execution of at least a portion of the application using at least one of the existing technology type via the cloud device and determine the one or more metrics for at least one of the one or more existing technology types based on the execution of at least a portion of the application using at least one of the existing technology type via the cloud device.

In various embodiments, the cloud device is one or more devices independent of the end-point device associated with the application and the one or more devices are connected on a network with the end-point device associated with the application. In various embodiments, the new technology performance indicator includes a ranking for each of the one or more metrics between the new technology type and at least one of the one or more existing technology types.

In various embodiments, the at least one processing device, upon execution of the instructions, is configured to cause rendering of a graphical user interface to the end-point device associated with the application with the graphical user interface including one or more icons in which the end-point device can indicate at least one of the one or more existing technology types or the one or more new technology types, and the application test request being generated based on an input via the graphical user interface.

In various embodiments, the at least one processing device, upon execution of the instructions, is configured to obtain at least a portion of application data used to execute the application with the at least a portion of the application data being used during the execution of the at least a portion of the application using the at least one of the one or more new technology types via the cloud device.

In various embodiments, the at least one processing device, upon execution of the instructions, is configured to generate an application test report including the new technology performance indicator for one or more of the new technology types and at least one of the one or more metrics for the application performed on the at least one of the one or more new technology types or one or more metrics for at least one of the one or more existing technology types, and cause a transmission of the application test report to the end-point device associated with the application.

In another example embodiment, a computer program product for determining system performance for application migration is provided. The computer program product includes at least one non-transitory computer-readable medium having computer-readable program code portions embodied therein. The computer-readable program code portions include one or more executable portions configured to receive an application test request from an end-point device associated with an application. The application test request includes an existing technology indicator and a new technology indicator. The existing technology indicator indicates one or more existing technology types in which an application operates, and the new technology indicator indicates one or more new technology types in which the application is to be tested. The computer-readable program code portions include one or more executable portions also configured to cause an execution of at least a portion of the application using the at least one of the one or more new technology types via a cloud device. The computer-readable program code portions include one or more executable portions further configured to compare one or more metrics for the application performed on the at least one of the one or more new technology types with one or more metrics for at least one of the one or more existing technology types. The computer-readable program code portions include one or more executable portions still further configured to determine a new technology performance indicator for each of the at least one of the one or more new technology types based on the comparison of the one or more metrics for the application performed on the at least one of the one or more new technology types with one or more metrics for at least one of the one or more existing technology types. The computer-readable program code portions include one or more executable portions also configured to cause a transmission of the new technology performance indicator for one or more of the new technology types to the end-point device associated with the application.

In various embodiments, the computer-readable program code portions including one or more executable portions are also configured to cause an execution of at least a portion of the application using at least one of the existing technology type via the cloud device, and determine the one or more metrics for at least one of the one or more existing technology types based on the execution of at least a portion of the application using at least one of the existing technology type via the cloud device.

In various embodiments, the cloud device is one or more devices independent of the end-point device associated with the application and the one or more devices are connected on a network with the end-point device associated with the application. In various embodiments, the new technology performance indicator includes a ranking for each of the one or more metrics between the new technology type and at least one of the one or more existing technology types.

In various embodiments, the computer-readable program code portions including one or more executable portions are also configured to cause rendering of a graphical user interface to the end-point device associated with the application with the graphical user interface including one or more icons in which the end-point device can indicate at least one of the one or more existing technology types or the one or more new technology types, and the application test request being generated based on an input via the graphical user interface.

In various embodiments, the computer-readable program code portions comprising one or more executable portions are also configured to obtain at least a portion of application data used to execute the application with the at least a portion of the application data being used during the execution of the at least a portion of the application using the at least one of the one or more new technology types via the cloud device.

In various embodiments, the computer-readable program code portions including one or more executable portions are also configured to generate an application test report including the new technology performance indicator for one or more of the new technology types and at least one of the one or more metrics for the application performed on the at least one of the one or more new technology types or one or more metrics for at least one of the one or more existing technology types, and cause a transmission of the application test report to the end-point device associated with the application.

In still another example embodiment, a method for determining system performance for application migration. The method includes receiving an application test request from an end-point device associated with an application. The application test request includes an existing technology indicator and a new technology indicator. The existing technology indicator indicates one or more existing technology types in which an application operates, and the new technology indicator indicates one or more new technology types in which the application is to be tested. The method also includes causing an execution of at least a portion of the application using the at least one of the one or more new technology types via a cloud device. The method further includes comparing one or more metrics for the application performed on the at least one of the one or more new technology types with one or more metrics for at least one of the one or more existing technology types. The method still further includes determining a new technology performance indicator for each of the at least one of the one or more new technology types based on the comparison of the one or more metrics for the application performed on the at least one of the one or more new technology types with one or more metrics for at least one of the one or more existing technology types. The method also includes causing a transmission of the new technology performance indicator for one or more of the new technology types to the end-point device associated with the application.

In various embodiments, the method also includes causing an execution of at least a portion of the application using at least one of the existing technology type via the cloud device and determining the one or more metrics for at least one of the one or more existing technology types based on the execution of at least a portion of the application using at least one of the existing technology type via the cloud device.

In various embodiments, the cloud device is one or more devices independent of the end-point device associated with the application and the one or more devices are connected on a network with the end-point device associated with the application. In various embodiments, the new technology performance indicator comprises a ranking for each of the one or more metrics between the new technology type and at least one of the one or more existing technology types.

In various embodiments, the method also includes causing rendering of a graphical user interface to the end-point device associated with the application with the graphical user interface including one or more icons in which the end-point device can indicate at least one of the one or more existing technology types or the one or more new technology types, and the application test request is generated based on an input via the graphical user interface.

In various embodiments, the method also includes obtaining at least a portion of application data used to execute the application with the at least a portion of the application data being used during the execution of the at least a portion of the application using the at least one of the one or more new technology types via the cloud device.

In various embodiments, the method also includes generating an application test report including the new technology performance indicator for one or more of the new technology types and at least one of the one or more metrics for the application performed on the at least one of the one or more new technology types or one or more metrics for at least one of the one or more existing technology types, and causing a transmission of the application test report to the end-point device associated with the application.

The features, functions, and advantages that have been discussed may be achieved independently in various embodiments of the present disclosure or may be combined with yet other embodiments, further details of which can be seen with reference to the following description and drawings.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1A-1C illustrate technical components of an exemplary distributed computing environment for determining system performance for application migration, in accordance with various embodiments of the present disclosure; and

FIGS. 2A and 2B illustrate a process flow for determining system performance for application migration, in accordance with various embodiments of the present disclosure.

### DETAILED DESCRIPTION

Embodiments of the present disclosure will now be described more fully hereinafter with reference to the accompanying drawings, in which some, but not all, embodiments of the disclosure are shown. Indeed, the various inventions may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers, or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure, and positioning (distal phalanges, intermediate phalanges, proximal phalanges, and the like)), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “cloud device” may refer to one or more device independent of an end-point device associated with a user. For example, the cloud device may be one or more devices independent of the end-point device associated with the application. The cloud device may be connected on a network with the end-point device associated with the application. The cloud device may use distributed computing to perform the operations of a cloud device. For example, a cloud device may use any components of the system 130 or other end-point devices 140. In various embodiments, components of the end-point device associated with the application may be used in association with the cloud device. The cloud device may also be in communication and/or be assisted by additional device (e.g., 3^{rd} party cloud devices that provide cloud processing).

Applications are constantly being retrofitted for different technologies. As such, each technology creates different issues relating to operability. However, application developers may not necessarily be able to put new technologies through full-scale testing before implementation due to the speed of technology advancement. As such, an application developer may use introduce a version of an application that is designed for an existing technology onto a new technology without such testing, resulting in unknown issues in operability, performance, and/or cost. Current testing methods do not allow for time sensitive and cost-effective testing that also allows for accurate results.

Various embodiments of the present disclosure allow for determining system performance for application migration. To do this, the system uses a cloud proof of concept tool that allows for an application to be executed on a new technology and the performance on the new technology can be compared to the performance on existing technology. The system receives an application test request from an end-point device associated with an application (e.g., an end-point device associated with a developer of the application). The application test request includes one or more existing technology types in which the application is currently used and one or more new technology types in which the application is to be tested. The application is executed on the new technology type(s) via a cloud device and one or more metrics relating to the performance, such as speed, usage, cost, and/or the like, are compared to one or more metrics for the same application on the one or more existing technology types. The results of the comparison may be provided to the end-point device associated with the application along with a report with other information relating to the test (e.g., the metrics for the new and/or existing technology types). As such, the system allows for the application to be executed using a cloud device that allows for developer processing capabilities to be preserved.

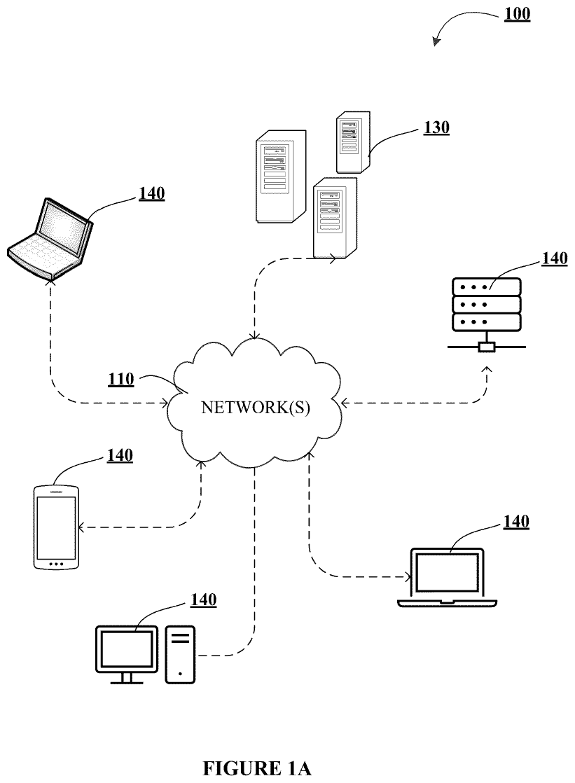

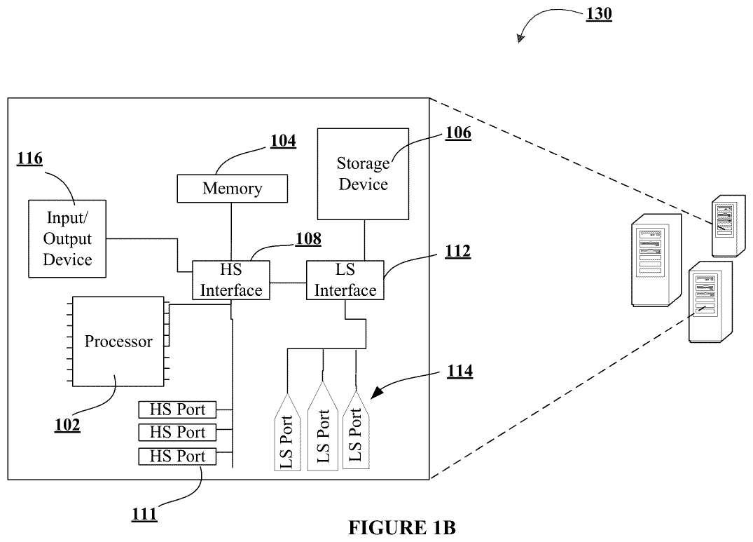

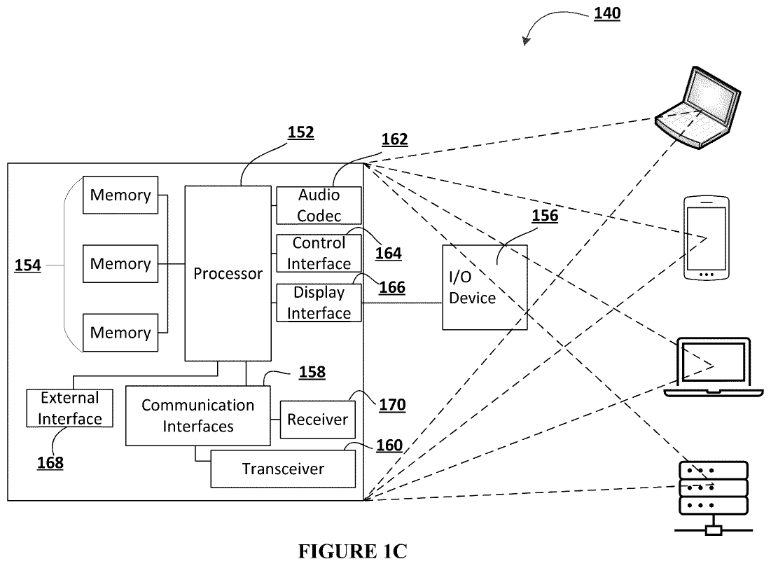

FIGS. 1A-1C illustrate technical components of an exemplary distributed computing environment for determining system performance for application migration, in accordance with various embodiments of the disclosure. As shown in FIG. 1A, the distributed computing environment 100 contemplated herein may include a system 130 (e.g., an application migration testing device), an end-point device(s) 140, and one or more networks 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network(s) 110. Instead of having a central server (e.g., system 130) which would act as the shared drive, each device that is connect to the network(s) 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network(s) 110 may be a distributed network that is spread over different networks. This provides a single data communication network, which can be managed jointly or separately by each network. Besides shared communication within the network, the distributed network often also supports distributed processing. The network(s) 110 may be a form of digital communication network such as a telecommunication network, a local area network (“LAN”), a wide area network (“WAN”), a global area network (“GAN”), the Internet, satellite network, cellular network, and/or any combination of the foregoing. The network(s) 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosure described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low-speed expansion port 114 (shown as “LS Port”) and storage device 106. Each of the components 102, 104, 106 108, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interfaces 158, and a transceiver 160, among other components. The end-point device(s) 140 may also be provided with a storage device, such as a micro-drive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single in Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network(s) 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through at least one of communication interfaces 158, which may include digital signal processing circuitry where necessary. Communication interfaces 158 may provide for communications under various modes or protocols, such as the Internet Protocol (IP) suite (commonly known as TCP/IP). Protocols in the IP suite define end-to-end data handling methods for everything from packetizing, addressing, and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interfaces 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130. The end-point device(s) 140 may include a communication interface that is configured to operate with a satellite network.

In various embodiments, the end-point device(s) 140 may have multiple communication interfaces that are configured to operate using the various communication methods discussed herein. For example, an end-point device 140 may have a cellular network communication interface (e.g., a communication interface that provides for communication under various telecommunications standards) and a satellite network communication interface (e.g., a communication interface that provides for communication via a satellite network). Various other communication interfaces may also be provided by the end-point device (e.g., an end-point device may be capable of communicating via a cellular network, a satellite network, and/or a wi-fi connection). Various communication interfaces may share components with other communication interfaces in the given end-point device.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

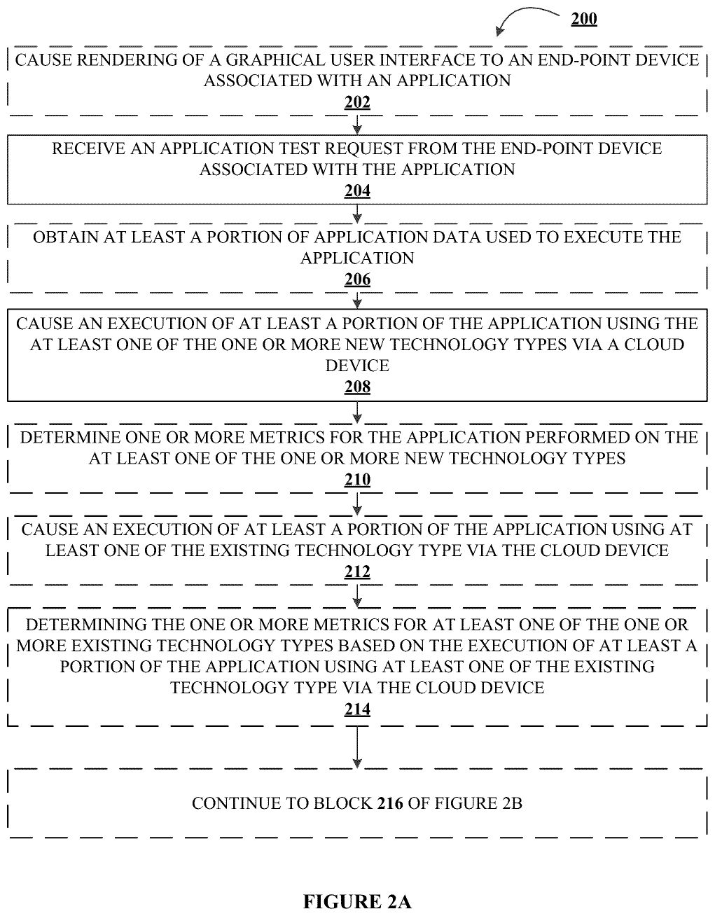

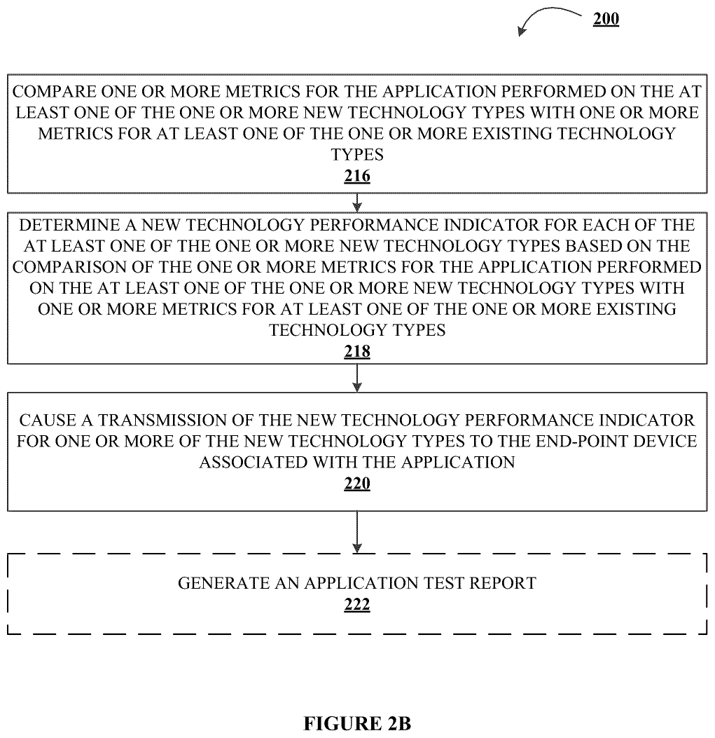

FIGS. 2A and 2B include a flow chart 200 that illustrates an example method of determining system performance for application migration. The method may be carried out by various components of the distributed computing environment 100 discussed herein (e.g., the system 130, one or more end-point devices 140, etc.). An example system may include at least one non-transitory storage device and at least one processing device coupled to the at least one non-transitory storage device. In such an embodiment, the at least one processing device is configured to carry out the method discussed herein. A method of various embodiments may include any combination or subset of the features discussed herein.

Referring now to optional Block 202 of FIG. 2A, the method includes causing rendering of a graphical user interface to an end-point device associated with an application. The graphical user interface may include one or more icons in which the end-point device can indicate at least one of the one or more existing technology types or the one or more new technology types. An end-point device associated with the application may be any end-point device that is associated with one or more users that have control and/or a relationship with the application. For example, an entity may be the developer of the application and the end-point device associated with the application may be an end-point device for a developer of the entity. In various embodiments, the system may be in communication with multiple end-point devices associated with the application (e.g., end-point devices for multiple developers). As such, the end-point device associated with an application may refer to multiple end-point devices in some embodiments. For example, a first end-point device for a first developer associated with the application may submit the application test request and a second end-point device for a second developer associated with the application may access information relating to the testing (e.g., during or after the testing process).

The application test request discussed below in reference to Block 204 of FIG. 2A may be generated based on an input via the graphical user interface. The system may receive an input from the end-point device via the user interface and/or another input method (e.g., keyboard, microphone, etc.). For example, a user may select an application to be tested, one or more existing technology types on which the application is used, and/or one or more new technology types in which the application is to be tested. The input via the graphical user interface may include additional information relating to the application test request, such as the cloud computing service in which to use during the execution of the application.

Referring now to Block 204 of FIG. 2A, the method includes receiving an application test request from the end-point device associated with the application. The application test request includes an existing technology indicator and a new technology indicator. The existing technology indicator indicates one or more existing technology types in which an application operates. The new technology indicator indicates one or more new technology types in which the application is to be tested. As used herein, a technology type may be any type of equipment and/or software version in which an application can be executed. Examples of technology types include computing devices, mobile devices, and/or the like (e.g., such as end-point devices 140).

The existing technology indicator may indicate one or more existing technology types in which an application operates. An existing technology type may be any technology type that the application has already been executed previously. For example, an existing technology type may be a mobile device running an operating system in which the application has been tested and ran previously. In various embodiments, the user and/or entity associated with the application may have existing metric and/or data relating to the application being executed on an existing technology type. Additionally or alternatively, as discussed herein, the system may also execute the application on the existing technology type(s) via the cloud device as discussed herein.

The new technology indicator indicates one or more new technology types in which the application is to be tested. A new technology type may be any technology type in which the application is to be tested. As such, a new technology type may be any technology type in which the application has not been ran and/or thoroughly tested. A new technology type may not necessarily be completely new, but instead is a new technology type is any technology type in which testing is desired for an application. Examples of new technology types may include new equipment (e.g., a new mobile device in which the application has not be executed), new software versions (e.g., an end-point device may receive an update that may change the functionality of the application), equipment and/or software in which little to no testing has been completed for the application, and/or the like.

In various embodiments, the application test request may include additional information relating to the testing to be completed. For example, the application test request may include the amount of application data to be received for application execution, whether the existing tech should be executed or if metrics from previous executions will be used, metric(s) to be monitored, weight of metrics being monitored, and/or the like. In various embodiments, the application test request may be a single data packet (e.g., including all of the application test request information) or multiple data packets (e.g., a first data packet with the existing technology indicator, a second data packet with the new technology indicator, etc.). In various embodiments, the application test request may be compiled based on multiple inputs from an end-point device associated with the application. For example, the end-point device associated with the application may provide the existing technology indicator and the new technology indicator, then the system may request additional information relating to the testing, such as metrics to be tested, type of testing to be completed, and/or the like.

Referring now to optional Block 206 of FIG. 2A, the method includes obtaining at least a portion of application data used to execute the application. The at least a portion of the application data is used during the execution of the at least a portion of the application using the at least one of the one or more new technology types.

In various embodiments, the system may receive application data in order to execute the application. The application data may include all of the application data typically used to execute the application. Alternatively, the system may receive a portion of the application data, in order to execute specific portions of the application. The amount of application data received may be based on the type of testing completed. For example, the more robust the test, the more application data may be received. In various embodiments, the application test request may indicate the amount of application data and/or the specific application data to be received by the system to execute the application.

In various embodiments, the system may have a predefined amount of application needed to execute the application. In various embodiments, the system may analyze the application and determine the amount of application needed to execute the test based on the contents of the application. For example, the coding of the application may indicate, either explicitly or via context, the amount of application necessary to execute (e.g., an application may indicate the type of application data and the amount of application data in order to be executed).

In various embodiments, the system may cause a prompt to be rendered to the end-point device associated with the application (e.g., a prompt on the graphical user interface). In such an instance, the prompt may allow the amount of application data to be transferred to the system to be indicated. For example, a user associated with the end-point device may select the level of testing (e.g., quick test may require less application data than a complete test). As such, the system may receive the amount of application data to be received and/or the type of test to be completed.

In various embodiments, the end-point device associated with the application may transmit the at least a portion of application data to the system. Additionally or alternatively, the end-point device associated with the application may indicate the location in which application data is stored in order for the system to obtain the application data (e.g., the system may request and/or receive the application data from an independent computing device).

Referring now to Block 208 of FIG. 2A, the method includes causing an execution of at least a portion of the application using the at least one of the one or more new technology types via a cloud device. The cloud device is one or more devices independent of the end-point device associated with the application and the one or more devices are connected on a network with the end-point device associated with the application.

The amount of the application executed may be based on the type of testing. For example, a start-up test may require less of the application to be executed than a full test of the application. In various embodiments, the testing type may be based on the type of application. For example, the testing may simulate one or more typical operations for the application. Additionally or alternatively, the testing may include strain testing to determine weaknesses in the application.

The application may be executed on a device independent of the end-point device associated with the application. For example, the application may be executed using a cloud computing service and/or a remote computing device configured to execute application. In various embodiments, the cloud device may be capable of simulating conditions of the given new technology type and/or the cloud device may include characteristics of the given new technology type (e.g., the cloud device may include the software version of the new technology type).

Referring now to optional Block 210 of FIG. 2A, the method includes determining one or more metrics for the application performed on the at least one of the one or more new technology types. Example metrics include operating speed, component usage, cost of operation, and/or the like.

A metric for the application may be any measurable statistics relating to performance, cost, and/or efficiency of the application during execution. For example, the metrics may include component performance (e.g., component speed, component heat, etc.), overall performance (e.g., speed of application execution, data usage during execution, etc.), cost (e.g., the cost to execute the application for a specific time period), and/or the like. The metrics may be metrics that are commonly monitored relating to application execution (e.g., speed, usage, component performance, etc.). In various embodiments, the system may monitor specific metrics based on the application. For example, the application test request may include the metrics to be monitored and/or compared (e.g., the end-point device associated with the application may provide the system with one or more key metrics to monitor). The system may include one or more predefined metric(s) to monitor during the execution of the application (e.g., the system may monitor the same or similar metrics across every test).

Referring now to optional Block 212 of FIG. 2A, the method includes causing an execution of at least a portion of the application using at least one of the existing technology type via the cloud device. In some embodiments, the system may cause execution of the application on one or more new technology types and one or more of the existing technology types, such that the application is executed under similar conditions. Additionally or alternatively, the application may not be executed on the existing technology type(s) and the metric(s) for the one or more existing technology types may be obtained via alternative methods (e.g., the metric(s) may be recorded during previous execution of the application on the existing technology type). For example, the system may receive the metric(s) for the given existing technology type that were recorded during previous execution.

The amount of the application executed may be based on the type of testing. The amount of the application executed may be the approximately the same as the amount of the application executed on the one or more new technology types (e.g., to allow for the comparison of the metrics obtained). The application may be executed on a device independent of the end-point device associated with the application. For example, the application may be executed using a cloud computing service and/or a remote computing device configured to execute application. In various embodiments, the cloud device may be capable of simulating conditions of the existing technology type.

In various embodiments, each of the application executions may be completed in parallel via the cloud devices. As such, the system may determine the metrics for which to compare the new technology type(s) and the existing technology type(s) at the same or similar times, such that the comparison can be expedited, as opposed to dedicated testing that is completed sequentially.

Referring now to optional Block 214 of FIG. 2A, the method includes determining the one or more metrics for at least one of the one or more existing technology types based on the execution of at least a portion of the application using at least one of the existing technology type via the cloud device. The one or more metrics for at least one of the one or more existing technology types may be the same type of metric as obtained for the at least one of the one or more new technology types. As such, direct comparisons may be used between the existing technology type(s) and the new technology type(s). in various embodiments, the one or more metrics for at least one of the one or more existing technology types may be obtained based on the execution of the application on the existing technology type(s) and/or based on stored metric(s) based on previous executions of the application on the existing technology type(s) (e.g., metrics may be regularly monitored and/or recorded during use of the application across various technology types).

Referring now to Block 216 of FIG. 2B, the method includes comparing one or more metrics for the application performed on the at least one of the one or more new technology types with one or more metrics for at least one of the one or more existing technology types. In various embodiments, like metrics for the new technology type(s) and the existing technology type(s) are compared to determine performance of the application on new technology types. For example, the application execution speed for a new technology type may be compared to the application execution speed for an existing technology type.

In various embodiments, the comparison of the metrics may be a determined of whether the application performed better, worse, or the same on the given new technology as the application performed on one or more of the existing technology types. Such a designation may be included in the new technology performance indicator discussed below. In various embodiments, the definition of better, worse, and/or the same may be based on the type of metric. For example, an application execution speed that is faster for the new technology type may be designated as better, an application execution speed that is approximately the same for the new technology type as the existing technology type may be designated as the same, and an application execution speed that is slower for the new technology type than the existing technology type may be designated as worse. In various embodiments, the designation may be based on a range (e.g., in an instance in which a metric for the application executed on the new technology type is within a predetermined percentage of the metric executed on the existing technology type, the new technology performance indicator may indicate that the performance of the application on the new technology type is approximately the same as the performance of the application on the existing technology type for the given metric).

In various embodiments, each of the metrics compared may carry the same weight (e.g., the new technology type is determined to perform between than the existing technology type in an instance more metrics are favorable to the new technology type). In various embodiments, one or more of the metrics compared may be weighted (e.g., one or more metric may be more important to the execution of the application). The weight of a metric may have a predefined value (e.g., certain metrics may be favorable over other metrics in any comparison). Additionally or alternatively, the weight of the metric may be based on the type of the application (e.g., the application test request may include specific metrics that are more important than other metrics).

In various embodiments, the comparison of the metrics may include determining the difference between a given metric on each technology type. For example, in an instance in which the metric is application execution speed, a slight difference between the application execution speed on the new technology type and the existing technology type may be less of an issue than a large difference (e.g., an instance in which the new technology is significantly slower than an existing technology type may indicate an issue with the application on the new technology type). As such, the new technology performance indicator discussed below may indicate that the new technology type is potentially incompatible with the application (e.g., the application may need changes in order to perform similarly and/or better on the new technology type than the application performs on the existing technology type(s)).

Referring now to Block 218 of FIG. 2B, the method includes determining a new technology performance indicator for each of the at least one of the one or more new technology types based on the comparison of the one or more metrics for the application performed on the at least one of the one or more new technology types with one or more metrics for at least one of the one or more existing technology types.

In various embodiments, the new technology performance indicator may indicate the likelihood of the application being compatible with the new technology type. An application may be compatible with a new technology type when one or more of the metrics are not substantially affected by the change from one or more existing technology types to the given new technology type. For example, a new technology performance indicator may indicate that an application is compatible with a new technology type in an instance in which the metrics from the application being executed on the new technology type are within a predetermined range of the metrics from the application being executed on a given existing technology type.

In various embodiments, the new technology performance indicator includes a ranking for each of the one or more metrics between the new technology type and at least one of the one or more existing technology types. As discussed above, different metrics may have more or less weight than other metrics. As such, the new technology performance indicator may indicate how the metrics compare between the given new technology type and the existing technology type(s), as well as which metrics are more important than others for the application (e.g., which metrics have more weight). For example, the new technology performance indicator may include a chart in which the metrics are ordered by weighted value with each comparison shown.

In various embodiments, the system may determine one or more recommendations on how to improve performance, cost, and/or efficiency of the application on a given new technology type. For example, the system may analyze the metrics and/or other metadata relating to the application execution on the new technology type and determine areas in which the application execution is abnormal. In various embodiments, the pattern of the metrics of the application performed on the new technology type may be compared to the pattern of the metrics of the application performed on the existing technology type. For example, a metric (e.g., the application execution speed) may be similar between the given new technology type and the given existing technology type during most of the application execution, but the given metric may be reduced during a certain portion of the application execution. As such, the system may recommend reviewing a specific portion of the application for modification (e.g., a certain plugin or code may be negatively affecting the application performance on the new technology type).

Referring now to Block 220 of FIG. 2B, the method includes causing a transmission of the new technology performance indicator for one or more of the new technology types to the end-point device associated with the application. The new technology performance indicator may be provided to the end-point device associated with the application (e.g., via the same or similar graphical user interface in which the input is received discussed in Block 202 of the FIG. 2A). Additionally or alternatively, the new technology performance indicator may be transmitted via various communication methods, such as electronic mail. The new technology performance indicator may be included in application test report discussed below in reference to Block 222 of FIG. 2B (e.g., the application test report including the new technology performance indicator may be caused to be transmitted in the same fashion as discussed in reference to the new technology performance indicator being caused to be transmitted).

In various embodiments, the system may cause a rendering to the graphical user interface based on the new technology performance indicator for one or more of the new technology types. The rendering may be information included in the new technology performance indicator. The rendering may also include one or more recommendations for improving the application performance.

Referring now to optional Block 222 of FIG. 2B, the method includes generating an application test report. The application test report includes the new technology performance indicator for one or more of the new technology types and at least one of the one or more metrics for the application performed on the at least one of the one or more new technology types or one or more metrics for at least one of the one or more existing technology types. The application test report may be transmitted to the end-point device associated with the application.

The application test report may include additional information relating to the operations discussed herein, such as the metrics for one or more of the tests performed (e.g., on the new technology type(s) and/or the existing technology type(s)); recommendations on how to improve performance, cost, and/or efficiency of the application execution on the new technology type, and/or the like. The application test report may include any information used by a developer to investigate or otherwise modify an application for execution on a new technology type.

The application test report may also include information relating to the cloud device(s) used during the execution of the application. For example, different cloud computing device may provide different results and the application may perform better on one cloud device than another cloud device. As such, the system may determine the application metrics across multiple cloud devices (e.g., the application may be caused to be executed on the new technology type across multiple cloud devices). In such an instance, the different metrics may be used to determine one or more cloud devices to use during execution of the application. For example, an application may use a given cloud device to assist in the processing of data using a given technology type once the application is rolled out to the new technology type (e.g., a cloud device may be used to reduce strain on the new technology type). As such, the system may provide information relating to the performance of one or more cloud devices.

As will be appreciated by one of ordinary skill in the art, various embodiments of the present disclosure may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present disclosure may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present disclosure may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present disclosure, however, the computer-readable medium may be transitory, such as a propagation signal including computer-executable program code portions embodied therein.

It will also be understood that one or more computer-executable program code portions for carrying out the specialized operations of the present disclosure may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present disclosure are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present disclosure are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present disclosure.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications, and substitutions, in addition to those set forth in the above paragraphs, are possible. Those skilled in the art will appreciate that various adaptations and modifications of the just described embodiments can be configured without departing from the scope and spirit of the disclosure. Therefore, it is to be understood that, within the scope of the appended claims, the disclosure may be practiced other than as specifically described herein.

What is claimed is:

1. A system for determining system performance for application migration, the system comprising:
at least one non-transitory storage device containing instructions; and
at least one processing device coupled to the at least one non-transitory storage device, wherein the at least one processing device, upon execution of the instructions, is configured to:
receive an application test request from an end-point device associated with an application, wherein the application test request comprises an existing technology indicator and a new technology indicator, wherein the existing technology indicator indicates one or more existing technology types in which an application operates, and wherein the new technology indicator indicates one or more new technology types in which the application is to be tested;
cause an execution of at least a portion of the application using the at least one of the one or more new technology types via a cloud device;
compare one or more metrics for the application performed on the at least one of the one or more new technology types with one or more metrics for at least one of the one or more existing technology types;
determine a new technology performance indicator for each of the at least one of the one or more new technology types based on the comparison of the one or more metrics for the application performed on the at least one of the one or more new technology types with one or more metrics for at least one of the one or more existing technology types; and
cause a transmission of the new technology performance indicator for one or more of the new technology types to the end-point device associated with the application.

2. The system of claim 1, wherein the at least one processing device, upon execution of the instructions, is configured to:
cause an execution of at least a portion of the application using at least one of the existing technology type via the cloud device; and
determine the one or more metrics for at least one of the one or more existing technology types based on the execution of at least a portion of the application using at least one of the existing technology type via the cloud device.

3. The system of claim 1, wherein the cloud device is one or more devices independent of the end-point device associated with the application and the one or more devices are connected on a network with the end-point device associated with the application.

4. The system of claim 1, wherein the new technology performance indicator comprises a ranking for each of the one or more metrics between the new technology type and at least one of the one or more existing technology types.

5. The system of claim 1, wherein the at least one processing device, upon execution of the instructions, is configured to cause rendering of a graphical user interface to the end-point device associated with the application, wherein the graphical user interface comprises one or more icons in which the end-point device can indicate at least one of the one or more existing technology types or the one or more new technology types, and wherein the application test request is generated based on an input via the graphical user interface.

6. The system of claim 1, wherein the at least one processing device, upon execution of the instructions, is configured to obtain at least a portion of application data used to execute the application, wherein the at least a portion of the application data is used during the execution of the at least a portion of the application using the at least one of the one or more new technology types via the cloud device.

7. The system of claim 1, wherein the at least one processing device, upon execution of the instructions, is configured to:
generate an application test report, wherein the application test report comprises the new technology performance indicator for one or more of the new technology types and at least one of the one or more metrics for the application performed on the at least one of the one or more new technology types or one or more metrics for at least one of the one or more existing technology types; and
cause a transmission of the application test report to the end-point device associated with the application.

8. A computer program product for determining system performance for application migration, the computer program product comprising at least one non-transitory computer-readable medium having computer-readable program code portions embodied therein, the computer-readable program code portions comprising one or more executable portions configured to:
receive an application test request from an end-point device associated with an application, wherein the application test request comprises an existing technology indicator and a new technology indicator, wherein the existing technology indicator indicates one or more existing technology types in which an application operates, and wherein the new technology indicator indicates one or more new technology types in which the application is to be tested;
cause an execution of at least a portion of the application using the at least one of the one or more new technology types via a cloud device;
compare one or more metrics for the application performed on the at least one of the one or more new technology types with one or more metrics for at least one of the one or more existing technology types;
determine a new technology performance indicator for each of the at least one of the one or more new technology types based on the comparison of the one or more metrics for the application performed on the at least one of the one or more new technology types with one or more metrics for at least one of the one or more existing technology types; and
cause a transmission of the new technology performance indicator for one or more of the new technology types to the end-point device associated with the application.

9. The computer program product of claim 8, wherein the computer-readable program code portions comprising one or more executable portions are also configured to:
cause an execution of at least a portion of the application using at least one of the existing technology type via the cloud device; and
determine the one or more metrics for at least one of the one or more existing technology types based on the execution of at least a portion of the application using at least one of the existing technology type via the cloud device.

10. The computer program product of claim 8, wherein the cloud device is one or more devices independent of the end-point device associated with the application and the one or more devices are connected on a network with the end-point device associated with the application.

11. The computer program product of claim 8, wherein the new technology performance indicator comprises a ranking for each of the one or more metrics between the new technology type and at least one of the one or more existing technology types.

12. The computer program product of claim 8, wherein the computer-readable program code portions comprising one or more executable portions are also configured to cause rendering of a graphical user interface to the end-point device associated with the application, wherein the graphical user interface comprises one or more icons in which the end-point device can indicate at least one of the one or more existing technology types or the one or more new technology types, and wherein the application test request is generated based on an input via the graphical user interface.

13. The computer program product of claim 8, wherein the computer-readable program code portions comprising one or more executable portions are also configured to obtain at least a portion of application data used to execute the application, wherein the at least a portion of the application data is used during the execution of the at least a portion of the application using the at least one of the one or more new technology types via the cloud device.

14. The computer program product of claim 8, wherein the computer-readable program code portions comprising one or more executable portions are also configured to:
generate an application test report, wherein the application test report comprises the new technology performance indicator for one or more of the new technology types and at least one of the one or more metrics for the application performed on the at least one of the one or more new technology types or one or more metrics for at least one of the one or more existing technology types; and
cause a transmission of the application test report to the end-point device associated with the application.

15. A method for determining system performance for application migration, the method comprising:
receiving an application test request from an end-point device associated with an application, wherein the application test request comprises an existing technology indicator and a new technology indicator, wherein the existing technology indicator indicates one or more existing technology types in which an application operates, and wherein the new technology indicator indicates one or more new technology types in which the application is to be tested;
causing an execution of at least a portion of the application using the at least one of the one or more new technology types via a cloud device;
comparing one or more metrics for the application performed on the at least one of the one or more new technology types with one or more metrics for at least one of the one or more existing technology types;
determining a new technology performance indicator for each of the at least one of the one or more new technology types based on the comparison of the one or more metrics for the application performed on the at least one of the one or more new technology types with one or more metrics for at least one of the one or more existing technology types; and
causing a transmission of the new technology performance indicator for one or more of the new technology types to the end-point device associated with the application.

16. The method of claim 15, further comprising:
causing an execution of at least a portion of the application using at least one of the existing technology type via the cloud device; and
determining the one or more metrics for at least one of the one or more existing technology types based on the execution of at least a portion of the application using at least one of the existing technology type via the cloud device.

17. The method of claim 15, wherein the cloud device is one or more devices independent of the end-point device associated with the application and the one or more devices are connected on a network with the end-point device associated with the application.

18. The method of claim 15, further comprising causing rendering of a graphical user interface to the end-point device associated with the application, wherein the graphical user interface comprises one or more icons in which the end-point device can indicate at least one of the one or more existing technology types or the one or more new technology types, and wherein the application test request is generated based on an input via the graphical user interface.

19. The method of claim 15, further comprising obtaining at least a portion of application data used to execute the application, wherein the at least a portion of the application data is used during the execution of the at least a portion of the application using the at least one of the one or more new technology types via the cloud device.

20. The method of claim 15, further comprising:
generating an application test report, wherein the application test report comprises the new technology performance indicator for one or more of the new technology types and at least one of the one or more metrics for the application performed on the at least one of the one or more new technology types or one or more metrics for at least one of the one or more existing technology types; and
causing a transmission of the application test report to the end-point device associated with the application.
